(19) United States
(12) Patent Application Publication
(10) Pub. No.: US 2024/0109424 A1
(43) Pub. Date: Apr. 4, 2024

(54) VEHICLE OPERATING METHOD AND SYSTEM

(71) Applicant: Transportation IP Holdings, LLC, Norwalk, CT (US)

(72) Inventors: Jennifer Sobierajski, Erie, PA (US); Timothy Warren Brown, Erie, PA (US); James Ghofulpo, Erie, PA (US); Jeffrey John Wolff, Erie, PA (US); Ajith Kuttannair Kumar, Ashburn, VA (US)

(21) Appl. No.: 18/458,508

(22) Filed: Aug. 30, 2023

Related U.S. Application Data
(60) Provisional application No. 63/412,097, filed on Sep. 30, 2022.

(51) Int. Cl. B60L 5/28

(52) U.S. Cl. CPC B60L 5/28; B60L 2200/26

(57) ABSTRACT

A method for operating a collector assembly of a vehicle that receives electric current from a conductive pathway extending along a route being traversed by the vehicle to power loads of the vehicle. The method includes moving the collector assembly relative to the conductive pathway to examine one or more mechanical components of the collector assembly and sensing one or more electrical characteristics of the electric current conducted to the vehicle from the conductive pathway and through the collector assembly to test electrical components of the collector assembly or the vehicle. The method may implement responsive actions to control operation of the vehicle based on outcomes of one or more of an examination of the mechanical components or the test of the electrical components.

### CROSS-REFERENCE TO RELATED APPLICATIONS

This application claims priority to U.S. Provisional Application No. 63/412,097, filed on Sep. 30, 2022, the entire disclosure of which is incorporated herein by reference.

### BACKGROUND

### Technical Field

Examples of the subject matter herein relate to methods and systems of testing a collector assembly of a vehicle or vehicle system, or components thereof.

### Discussion of Art

Vehicles may be made up of a number of components working together to move the vehicle forward. The components may include motors, engines, sensors, displays, fans, wheels, braking systems, among other components. The components may be mechanical assemblies, electrical assemblies, or a combination of both.

In one example, the components may include a collector assembly, such as a pantograph, that may be mounted on a roof of the vehicle. A pantograph is an apparatus mounted on a vehicle, which often may be attached to an electric train, tram, or electric bus to collect power through contact with an overhead conductive pathway or a catenary. The conductive pathway may extend along a route being traveled by the vehicle. The conductive pathway may power loads to the vehicle. The pantograph may be spring-loaded to push a contact shoe up against the underside of the conductive pathway to draw the current needed to run the vehicle. Return current may run through the route being traveled. As the vehicle moves, the contact shoe may slide along the conductive pathway and may set up standing waves in the wires which break the contact and degrade current collection. It may be desirable to test each component, such as the pantograph, for the vehicle to operate with efficiency and reliability.

In the event one or more of the components test below a predetermined threshold of performance, the testing system may implement responsive actions. For example, the testing system may prevent movement of the vehicle until the test exceeds the predetermined threshold. Additionally, the testing system may operate in a degraded or low power state based on a given outcome of the tests of the components.

The testing system may provide step-by-step guidance for an operator of the vehicle to run the test, or the testing system may run the test autonomously, without a user input. The test may be run prior to any defect or default occurring; thus the testing system may function as a preventative measure rather than the testing system being run responsive to an error or issue. It may be desirable to have a system and method that differs from those that are currently available.

### BRIEF DESCRIPTION

In accordance with one example or aspect, a method for operating a collector assembly of a vehicle is described. During operation, the function of the collector assembly may be tested and/or examined. The collector assembly may receive electric current from a conductive pathway extending along a route being traveled by the vehicle. The electric current may power loads of the vehicle. The method may include examining one or more mechanical components of the collector assembly of the vehicle by moving the collector assembly of the vehicle relative to the conductive pathway. The method may include sensing one or more electrical characteristics of the electric current received by the collector assembly of the vehicle from the conductive pathway to test one or more electrical components of one or more of the collector assembly or the vehicle. The method may include implementing one or more responsive actions to control operation of the vehicle based on outcomes of one or more of an examination of the one or more mechanical components or the test of the one or more electrical components.

In accordance with another example or aspect, a system is provided that may include a collector assembly, a controller, and a first sensor. The collector assembly may be disposed onboard a vehicle that travels along a route. The collector assembly may receive electric current from a conductive pathway extending along the route to power loads of the vehicle. The controller may initiate movement of the collector assembly relative to the conductive pathway to test one or more mechanical components of the collector assembly. The first sensor may sense one or more electrical characteristics of the electric current received by the collector assembly from the conductive pathway to test one or more electrical components of one or more of the collector assembly or the vehicle. The controller may implement one or more responsive actions to control operation of the vehicle based on outcomes of one or more of the test of the one or more mechanical components and the test of the one or more electrical components.

In accordance with one example or aspect, a method for testing a collector assembly of a vehicle is described. The collector assembly may receive electric current from a conductive pathway extending along a route being traveled by the vehicle. The electric current may power loads of the vehicle. The method may include moving the collector assembly of the vehicle to test one or more mechanical components of the collector assembly. The method may include sensing one or more electrical characteristics of the electric current received by the collector assembly to test one or more electrical components of the collector assembly or the vehicle. The method may include preventing operation of the vehicle until outcomes of the test of the one or more mechanical components are above a minimum mechanical threshold and the test of the one or more electrical components are above a minimum electrical threshold.

### BRIEF DESCRIPTION OF THE DRAWINGS

The subject matter may be understood from reading the following description of non-limiting examples, with reference to the attached drawings, wherein below:

FIG. 1 is a side view of a vehicle, a collector assembly, and a conductive pathway, according to one example;

FIG. 2 is a side view of the collector assembly of the vehicle illustrated in FIG. 1, according to one example;

FIG. 3 is a schematic overview of a vehicle, according to one example;

FIG. 4 is a side view of the vehicle, the collector assembly, and the conductive pathway illustrated in FIG. 1, shown with the collector assembly in a raised position, according to one example;

FIG. 5 is a side view of the vehicle, the collector assembly, and the conductive pathway illustrated in FIG. 1, shown with the collector assembly in a lowered position, according to one example;

FIG. 6 is a schematic view of a display, according to one example;

FIG. 7 is a method for operating a collector assembly of a vehicle, according to one example; and

FIG. 8 a functional block diagram of an example neural network that can be used by a vehicle testing system, according to one example.

### DETAILED DESCRIPTION

Embodiments of the subject matter described herein may relate to methods and systems of testing a vehicle or vehicle system, or components thereof. Specifically, a method or system for testing a collector assembly of a vehicle that receives electric current from a conductive pathway extending along a route being traveled by the vehicle. The electric current may power loads of the vehicle. A test or a series of tests may be run on a vehicle or the components of the vehicle. The test or tests may be run by an operator of the vehicle or may be designed as a self-test that may be able to run independent of operator or user interaction. In one embodiment, the test may be done by service personnel, for example in a maintenance shop. The self-test feature may be incorporated into the vehicle controls and may enable a testing facility to examine various components functionality, improve reliability, and increase safety of the vehicle.

The testing method or system may occur before a trip, during a trip, or after a trip. The testing may occur in response to an issue being detected on the vehicle or may occur preemptively before any issue arises. In one example, the testing may be executed before a vehicle trip. The vehicle may be required to successfully pass the given test or tests before further operation of the vehicle may be permitted. If a test or multiple tests are not successfully passed prior to the trip, operation of the vehicle may be inhibited and inspection, maintenance, or repair of the vehicle may be requested. Tests may be triggered selectively based at least in part on the trip type (or aspects of the trip) and/or a schedule associated with the vehicle (such as departure time or time of day/day of week) and/or freight aspects that may be associated with the vehicle for the particular trip. Freight aspects may include priority of cargo delivery (refrigerated or perishable freight, etc.) or whether passenger vehicles may be occupied (or not), presence and/or amount of a load, and the like.

Where the vehicle may include overhead elements, especially extendable overhead elements (e.g., a pantograph), the testing may be performed in an open area to allow the extendable overhead elements to be fully extended without obstruction. In one example, the route may include an electrified rail and a collector assembly may be conductive shoes. The test may include lowering or extending the conductive shoes to contact the electrified rail.

The testing method or system may be used to test the components of the vehicle and when a test may be failed, the testing method or system may log the failure. The testing system may be able to determine which component failed, whether the component should be repaired or replaced, determine whether a repair was effective, determine a tolerance/degradation/trend to schedule maintenance, determine when the vehicle may be operated in a degraded mode of operation, and the like. The testing system may log, compile, track, and evaluate the test results over time to further fine-tune the testing method and possible responsive actions in response to test outcomes. The historical tracking of test results may be done manually by an operator or autonomously by a controller or computer system. In one example, the tracking of test results may be managed and analyzed by an artificial intelligence (AI) system or a machine learning system. Determinations may be made based at least in part on the AI system.

While one or more embodiments are described in connection with rail vehicles and rail vehicle systems, other embodiments are not connected to rail vehicles and rail vehicle systems. Unless expressly disclaimed or stated otherwise, the subject matter described herein extends to other types of vehicles or vehicle systems, such as automobiles, trucks (with or without trailers), buses, mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together (e.g., as a convoy).

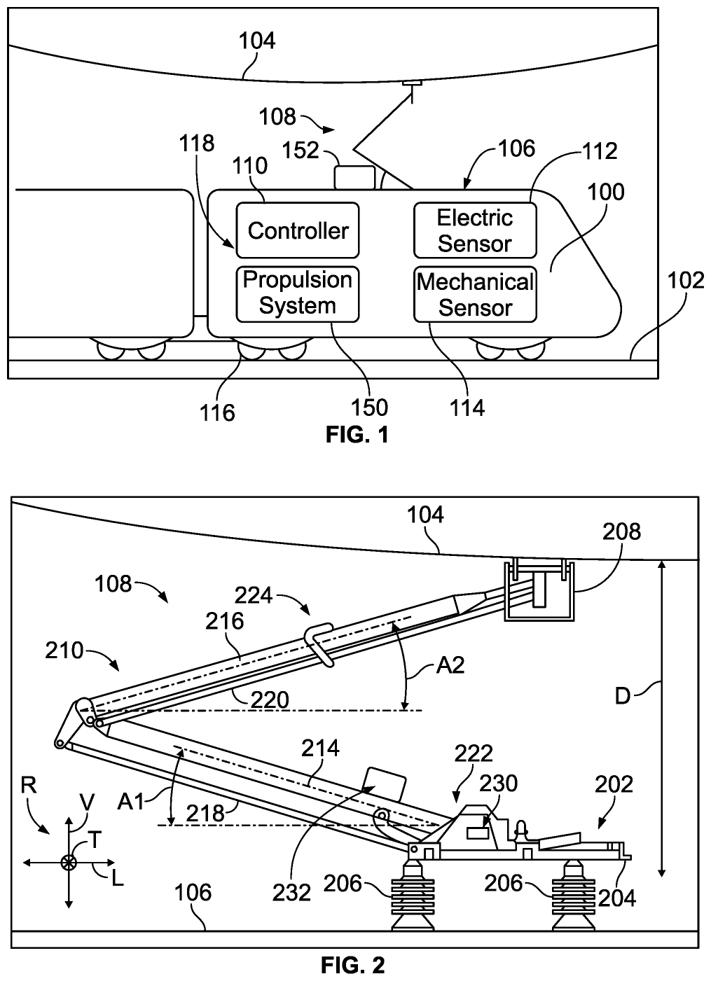

FIG. 1 illustrates one example of a testing system for testing a collector assembly 108 of a vehicle 100 that may receive electric current from a conductive pathway 104. The conductive pathway may extend along a route 102 being traveled by the vehicle to power loads of the vehicle. The loads of the vehicle may include power for a propulsion system 150, lights, control systems, displays, air conditioning, and the like. The propulsion system may operate to move the vehicle along the route. The propulsion system can represent one or more engines, motors, transmissions, propellers, or the like, that generate propulsion to move the vehicle system. In one example, the vehicle may be a trolley, electric train, electric bus, or an electric automobile. The vehicle may have a roof 106 at an upper portion, wheels 116 at a lower portion, and a body 118 extending between the roof and the wheels. The wheels may be positioned to engage the route being traveled by the vehicle.

In one example, the conductive pathway may include an overhead catenary line, as shown in FIG. 1. The conductive pathway may be an overhead trolley line, a traction wire, an overhead contact system, overhead equipment, an overhead line, or the like. The conductive pathway may be positioned over the route and may be connected to feeder stations at regular intervals which may provide electric power to the conductive pathway. The feeder stations may be electrically connected to a high-voltage electrical grid to provide electrical current and energy to the conductive pathway. The catenary line may engage the upper portion of the vehicle to provide the electric current to the vehicle.

In another example, the conductive pathway may be an electrified rail or rails over which the vehicle travels. The electrified rail may be a third rail that may run adjacent to or near a first and second rail that make up the route. The electrified rail may engage the lower portion of the vehicle, for example a conductive shoe, to provide the electric current to the vehicle. The wheels may engage the first and second rail, while the conductive shoe may engage the third rail.

The testing system may further include the collector assembly. The collector assembly may be positioned at the upper portion of the vehicle, such as a pantograph coupled to the roof of the vehicle. In other examples, the collector assembly positioned at the upper portion of the vehicle may include a bow collector, a trolley pole, or the like. The pantograph may raise to a position extended away from the roof of the vehicle and may lower to a position where the pantograph may generally be adjacent the roof of the vehicle. The pantograph may raise to engage the overhead catenary line to receive the electric current and provide the current to the vehicle. The pantograph may be electrically conductive with the catenary line, but the pantograph may include an insulated portion in contact with the roof of the vehicle.

The collector assembly may be positioned at the lower portion of the vehicle, such as a conductive shoe positioned at the lower portion of the vehicle. The conductive shoe may project laterally from the lower portion or may extend vertically downward to engage the electrified rail. The conductive shoe may lower or extend to engage the electrified rail to receive the electric current and provide the current to the vehicle. The first and second rails of the route may be metal, such as steel. Where the first and second rails are steel, the first and second rails may act as an electrical return for excess current supplied to the vehicle. The first and second rails may act as a grounding force, dissipating the excess current or may act to transport the excess current to a facility, such as the feeder station or the electrical grid. In one example, a fourth rail may be used. The fourth rail may serve as the electrical return system, such that excess current may be returned to the facility by the fourth rail.

The testing system may include a controller 110. The controller may be operably connected to or communicatively coupled with the vehicle and the collector assembly. For example, the controller may send electrical control signals to control the operations of these devices, and may receive information in the form of electrical signals from these devices. The controller may direct movement or initiate movement of the collector assembly, or components thereof, relative to the conductive pathway to test one or more mechanical components of the collector assembly. As discussed further below, the controller may direct movement of the collector assembly by activating a motor or drive to extend or retract which may raise or lower the collector assembly, respectively. The controller may allow user interaction to direct movement of the collector assembly. For example, the controller may have an input button that, when engaged by the user, directs the collector assembly to raise or lower. In one embodiment, the controller may move the collector assembly independent of user interaction. Said another way, the controller may operate autonomously.

The controller may have hardware circuitry that may include and/or may be connected with one or more processors (e.g., one or more microprocessors, integrated circuits, microcontrollers, field programmable gate arrays, etc.). The controller may represent one or more control units or devices that may be operably connected to perform the operations described herein. In an embodiment, the one or more processors may be disposed in a single, unitary control unit or controller. In another embodiment, the controller may include multiple different control units, and the processors may be distributed among the control units. The controller may include and/or may be connected with a tangible and non-transitory computer-readable storage medium (e.g., data storage device), referred to herein as memory. The memory may store program instructions (e.g., software) that are executed by the controller's one or more processors to perform the operations described herein. The program instructions may include one or more algorithms utilized by the controller's one or more processors to generate one or more outputs. In one example, the controller's one or more processors may implement machine learning or AI systems to generate the one or more outputs. The program instructions may provide functions, models, and/or neural networks used to generate the outputs. The program instructions may further dictate actions to be performed by a controller having one or more processors. While the controller shown in FIG. 1 may be shown within the vehicle system, in other examples the controller may be remote from the vehicle system.

In one example, the vehicle may include one or more converters 152 that may modify the electrical parameter from the conductive pathway. The converters may change one or more electrical parameters of the electrical energy received from the conductive pathway to a level or range that may be appropriate for use by the load of the vehicle. The electrical parameter that is changed may be voltage, phase, current, or the like. The converter may include a direct current to direct current (DC/DC) converter, a direct current to alternating current (DC/AC) converter, an AC/AC converter, an AC/DC converter, an inverter, rectifier, transformer, or the like that may modify a value of the electrical parameter of the electrical energy conducted from the conductive pathway to the vehicle.

The testing system may include sensors, such as a first sensor 112 and a second sensor 114. The sensors may be operably connected to the controller. The sensors may include electrical sensors or mechanical sensors. The sensors may measure a mechanical or an electrical output related to the collector assembly, or components thereof, being raised or lowered. The first and second sensors may be positioned in, on, or around the vehicle and may be used to sense characteristics related to the collector assembly, the vehicle, the conductive pathway, or a combination of one or all of three.

The electrical sensors may include an ohmmeter measuring electrical resistance, a voltmeter measuring electrical potential in volts, an impedance analyzer measuring impedance, an ammeter measuring current, a database or memory, a thermometer measuring a temperature of the energy storage system, an input device (e.g., control panel, switch, keyboard, microphone, etc.), or the like. The electrical sensors may read the electrical characteristics of the collector assembly, the vehicle, the conductive pathway, or a combination of the three. In one embodiment, at least one electrical sensor may monitor electric current conducted from the conductive pathway to the collector assembly onboard the vehicle. For example, a current sensor may sense the amount of electric current transferred from the conductive pathway to the collector assembly over time. The sensor may generate sensor data indicative of the measured amount of current received by the collector assembly. The sensor data may be transmitted via wired or wireless communication pathway to the controller on a periodic basis and/or on demand.

The mechanical sensor may include an optical sensor (e.g., an infrared sensor, a proximity detector), an acoustic sensor (e.g., an ultrasonic sensor), a capacitive sensor, a photoelectric sensor, an inductive sensor, a laser distance sensor (e.g., Light Detection and Raging “LIDAR”), or the like. The mechanical sensors may measure the physical characteristics of the collector assembly, the vehicle, the conductive pathway, or a combination of the three. Additionally, the mechanical sensors may measure components of the collector assembly, the vehicle, or the conductive pathway.

The sensors may generate an output to send to the controller. The sensors may communicate the outputs to the controller via a communication device. However, in one example, the sensors may communicate directly with the controller. The communication device may communicate with one or more other vehicle systems and/or other remote systems that are off-board the vehicle system, such as an off-board controller, a back-office control system, an off-board crew member, or the like. The communication device may include or represent an antenna (along with associated transceiver hardware circuitry and/or software applications) for wirelessly communicating with other vehicle systems and/or remote locations. Optionally, the communication device may communicate via one or more wired connections, such as a multiple unit (MU) cable, a trainline, an electrically controlled pneumatic (ECP) brake line, or the like.

The controller may include a storage of target or expected output values when the collector assembly may be in a fully operational state. The controller may use the one or more outputs measured from the sensors to determine an operational state of the collector assembly and the vehicle by comparing the measured outputs with the target outputs. For example, the controller may determine, based on the measured outputs, that the collector assembly requires repair, inspection, or maintenance. The controller may be able to use the determined operational state to determine a responsive action for the vehicle, as further discussed below.

When the controller directs the movement of the collector assembly relative to the conductive pathway, the second sensor or mechanical sensor may measure a height or position of the collector assembly when the collector assembly may be raised or lowered. The second sensor may be positioned inside the vehicle, on the roof of the vehicle, on or adjacent the collector assembly, or on or adjacent the conductive pathway. These positions may allow the mechanical sensor to measure the raised or lowered height. The mechanical sensor may communicate an output to the controller indicative of the height or position of the collector assembly.

The first sensor or electrical sensor may sense electrical characteristics of the electric current conducted to the vehicle from the conductive pathway. The electrical sensors may additionally sense electrical characteristics of the collector assembly and may test the electrical components of the collector assembly or the vehicle. For example, an electrical sensor may sense the amount of electric current transferred from the conductive pathway to the collector assembly over time or at a given time. In another example, an electrical sensor may sense the amount of electric current converted by the converter. The first and second sensors may output the measured and sensed characteristics to the controller. The controller may then implement responsive actions to control the operation of the vehicle based on one or both of the outcomes of the test of the mechanical components and the electrical components. The responsive actions may include preventing movement or operation of the vehicle, operating the vehicle in a limited power capacity, directing inspection of the vehicle, directing maintenance to the vehicle, replacing components of the vehicle, or the like. Additional details of the responsive actions are described herein.

In the example illustrated in FIG. 1, the collector assembly may be a pantograph that engages an overhead conductive line, however in other examples the collector assembly may include a conductive shoe that lowers or extends to engage an electrified rail. The collector assembly may include a bow collector, a trolley pole, or other collector components. The vehicle may be designed to travel on the route above which the conductive pathway or catenary extends to supply an electric current to the vehicle. The vehicle may include the roof upon which the pantograph may be coupled. The pantograph may be positioned to pick up the electrical supply current from the conductive pathway along the route. This electric supply current may supply electrical power to the vehicle.

With reference to FIG. 2, the pantograph will now be described in more detail. The pantograph may include a chassis 202 attached to the roof of the vehicle. The chassis may include a framework 204 and electrical insulators 206 connecting the framework to the roof of the vehicle. An index R may be used in reference to the chassis. The index may comprise a longitudinal direction L, a vertical direction V, and a transverse direction T (perpendicular to the plane of the sheet in FIG. 2). The longitudinal direction L and the vertical direction V together may define a vertical plane (the plane of the sheet in FIG. 2). The longitudinal direction L may correspond to the usual horizontal direction in the direction of travel when the vehicle travels on the route. Furthermore, the vertical direction V may correspond to the usual vertical direction. In the following description and claims, the terms used relative to positioning will be understood with reference to this index R.

The pantograph may include a bow 208 positioned to contact the catenary to pick up the supply current. The catenary may be located vertically at a greatly varying distance from the chassis. For example, this distance can vary between 600 mm and 3,600 mm. To compensate for variations in the distance between the catenary and the chassis, the pantograph may further include an articulated arm 210 connecting the bow to the chassis, such that the bow can be at a variable distance D from the chassis. The articulated arm may be designed to extend vertically to move the bow relative to the chassis for the purpose of maintaining the bow in contact with the catenary. In this way, the articulated arm may expand vertically so as to move the bow away from the chassis as the distance between the catenary and the chassis increases and, on the other hand, fold vertically back into itself to move the bow closer to the chassis as the distance between the catenary and the chassis decreases. In one example, the pantograph may be spring-loaded to push a contact shoe up against the underside of the conductive pathway to draw the current needed to run the vehicle.

The articulated arm may have plural parts. The articulated arm may include a lower main rod 214 transversely pivotally mounted on the chassis (for example, to the framework). The lower main rod may be at an angle A1 to the longitudinal direction L. The articulated arm may further include an upper main rod 216 transversely pivotally mounted on the lower main rod and at an angle A2 to the longitudinal direction L. The bow may be transversely pivotally mounted on the upper main rod.

The articulated arm may include an auxiliary lower rod transversely pivotally mounted on the chassis (e.g., on the framework) and on the upper main rod, to servo-link the angle A2 of the upper main rod to the angle A1 of the main lower rod, such that increasing the angle A1 may cause the angle A2 to increase. The articulated arm may include an upper auxiliary rod transversely pivotally mounted on the main lower rod and on the bow, such that the bow may maintain a substantially constant angle with the longitudinal direction L regardless of the extension of the articulated arm.

The pantograph may include a drive mechanism 222 designed to impel the articulated arm to expand. In this way, the bow may be maintained in contact with the catenary. The drive mechanism may be, for example, designed to rotate the lower main rod to increase the angle A1. The drive mechanism may include, for example, an electric motor, an air cushion, a spring 234, or the like. In one embodiment, the drive mechanism may include multiple springs. Optionally, when the pantograph is in the extended or raised position, one or more of the springs may apply tension that pulls the pantograph towards the retracted or lowered position. Optionally, one or more of the springs may bias the pantograph towards the extended position. The springs may enable the collector assembly to remain in intimate contact or proximity of the conductive pathway even as the height of the conductive pathway may vary between support poles.

The drive mechanism may include a driver 230, such as a spindle driver. The spindle driver may drive a spindle nut which may be coupled with the collector assembly, which may move the collector assembly between the raised position and the lowered position. The spindle drive assembly may include at least a motor and a gear box that control the raising and lowering of the collector assembly. The controller may actuate the spindle drive assembly to extend the collector assembly to the raised or extended position and to retract the pantograph to the lowered or retracted position. The spindle drive assembly may be indirectly connected to the collector assembly one of the springs. The motor may apply tension to the spring which causes a force imbalance in the springs. The force imbalance may raise and lower the collector assembly. In one embodiment, the motor may be electrically powered. A brake may selectively retain the collector assembly in place in a position, such as in the retracted position, the (fully) extended position, or an intermediate position between retracted and (fully) extended position. The brake may be integrated with the spindle drive assembly. For example, the brake may be on a shaft of the spindle drive assembly. The brake may block activity of the spindle drive assembly when the brake is engaged or active.

The pantograph may include one or more latches 232. The latches may secure the pantograph in the lowered or retracted position. The latches may be coupled to a latch actuator that may be actively controlled to lock and/or release the latches. The latch actuator may include a motor. For example, upon determining that the pantograph may be in the lowered or retracted position, the latch actuator may lock the latches to secure the pantograph. The latch actuator may release the latches to enable the spindle drive assembly and/or springs to extend (e.g., raise) the pantograph.

Given the complexity and number of moving components necessary to operate the vehicle and the collector assembly, it may be important to ensure that the components are fully operational by testing various aspects of the components. Various components (e.g., the drive mechanism, the spindle drivers, the latches, etc.) of the vehicle and the collector assembly may be tested or energized at different times to ensure each component of the various components may be functioning properly. The testing may occur before the vehicle embarks on a trip, at the conclusion of the trip, during the trip, or in response to an operating abnormality.

In order to start the testing process, there may be certain prerequisite criteria of the vehicle that may need to be met. The vehicle may need to be stationary, for example. Or, the vehicle may need to be in neutral and service brakes of the vehicle may need to be applied. In one example, the vehicle may need to have both the service brake and a parking brake applied. The collector assembly may need to be down or in a lowered position. The voltage applied to the collector assembly may need to be below a determined threshold height. The temperature of motors or engines of the vehicle may need to be within a certain temperature range.

Once the collector assembly has been confirmed to be in the proper situation (e.g., a lowered position and no voltage flowing from the collector assembly), the testing may begin. In one example, the collector assembly may be confirmed to be in a testing position and no voltage flowing from the collector assembly. The testing position may be a raised position or an intermediate position. In the example where the collector assembly starts in the lowered position, the operator may engage an up instruction or button for the collector assembly to initiate the collector assembly raising. A verification may occur that the collector assembly is in the raised position. In one embodiment, the collector assembly may be raised autonomously without operator interaction. Responsive to the instruction for the collector assembly to be raised, one or more latches of the collector assembly may be opened and a voltage may be applied to the driver to move the driver into an extended position. The sensor may measure the position of the driver and output the position of the driver to the controller. The controller may confirm the driver is in the extended position. The controller may compare the output from the driver in the extended position to a range of the driver in the extended position when the driver is fully operational. If the output is outside the range, the controller may determine that the driver may not be reaching the extended position and a responsive action, such as maintenance or inspection, may need to take place. The sensor may measure a maximum height reached of the collector assembly in the raised position. The controller may verify the measured height is in accordance with an operable maximum height. If the controller determines that the measured height may be below the operable maximum height, the controller may direct responsive actions, such as maintenance or inspection.

The operator may then engage a down instruction or button for the collector assembly to initiate the collector assembly lowering to the lowered position. A verification may occur that the collector assembly is in the lowered position. The verification may be from the operator verifying the collector assembly in the lowered position. The verification may be from the controller verifying the collector assembly in the lowered position by evaluating the output from the sensors. In one example, the collector assembly may be lowered autonomously without operator interaction. In response to the instruction for the collector assembly to be lowered, a voltage may be applied to the drivers to move the driver into a retracted position. The sensor may measure the position of the driver and output the position of the driver to the controller. The controller may confirm the driver is in the retracted position. The controller may compare the output from the driver in the retracted position to a range of the driver in the retracted position when the driver is fully operational. If the output is outside the range, the controller may determine that the driver may not be reaching the retracted position and a responsive action, such as maintenance or inspection, may need to take place. The controller may finally verify that the driver and the collector assembly have returned to the lowered position. Once the collector assembly is returned to the lowered position, the one or more latches of the collector assembly may be closed. The sensor may measure a minimum height reached of the collector assembly in the lowered position. The controller may verify the measured height is in accordance with an operable minimum height. If the controller determines that the measure height may be above the operable minimum height, the controller may direct responsive actions, such as maintenance or inspection. The controller may analyze the information from the tests to determine an operational state of the collector assembly.

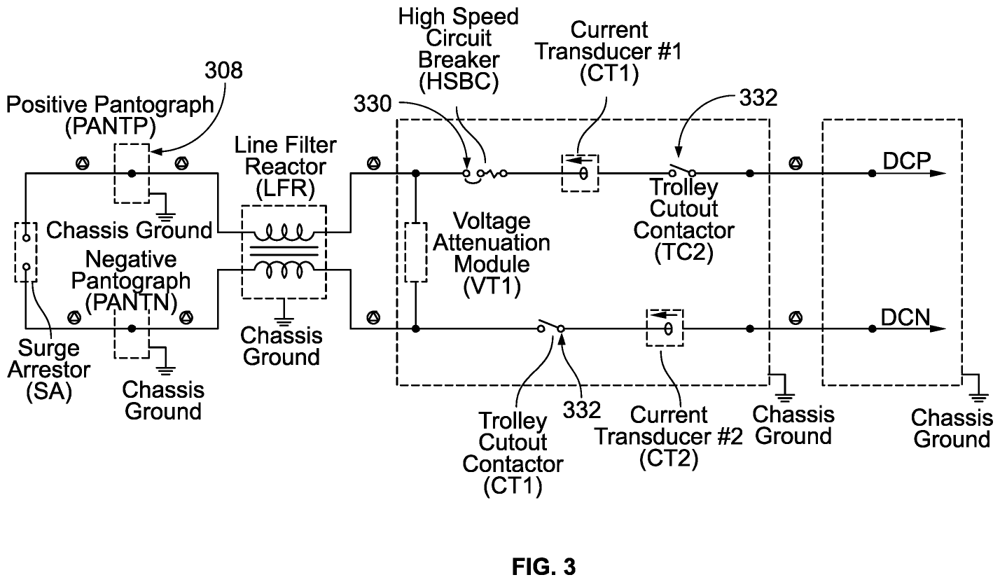

FIG. 3 illustrates a schematic overview of the vehicle. The vehicle includes a pantograph 308, a chassis, a breaker 330, and one or more contactors 332. The testing system of the collector assembly may further include testing electrical characteristics of the electric current conducted to the vehicle from the conductive pathway and through the collector assembly. The testing system may test electrical components of the collector assembly or the vehicle. The controller may receive a measurement of a current between the collector assembly and the conductive pathway. The controller may confirm whether the measured current is within an acceptable range for operating the vehicle. In one example, there may be an incoming current range for the collector assembly. If a measured incoming current from the conductive pathway through the collector assembly is outside of the incoming current range, operation of the vehicle may be inhibited. The incoming current range may vary based on a voltage of the electrification system. Additionally, the vehicle may include a sensor to identify ground faults.

The test may include applying a voltage to open the breaker of the vehicle. The controller may receive a breaker voltage in an open position from a sensor. The controller may then compare the measured breaker voltage with a determined target breaker voltage to determine whether the breaker may be in an operational state. If the difference between the measured breaker voltage and the determined target breaker voltage are more than 5% different, the controller may determine that the breaker is in a degraded state in the open position. In one example, the difference may be 1% to indicate the degraded state. In one example, the difference may be 10% to indicate the degraded state. Another voltage may be then applied to close the circuit breaker. The controller may receive the measured breaker voltage in a closed position and perform a similar analysis to the open position. The breaker may be a high-speed circuit breaker, an indirect trip circuit breaker, or the like.

Further, the test may include applying a voltage to open contactors of the collector assembly. FIG. 3 shows the contactors in an open position. Where there is more than one contactor, the test may close each contactor one at a time. In one example, the test may close all contactors at the same time. The controller may receive a sensor output related to the contactor in the open position. The controller may then compare the sensor output with a determined output of the contactor in the open position to determine whether the contactor may be in an operational state. If the difference between the sensor output and the determined output are more than 5% different, the controller may determine that the contactors are in a degraded state in the open position. In one example, the difference may be 1% to indicate the degraded state. In one example, the difference may be 25% to indicate the degraded state. The controller may calibrate the sensor outputs received over time in order to more accurately determine the effective range between the determined output and the sensor output. Another voltage may be then applied to close the contactor. The controller may receive the sensor output related to the contactor in a closed position and perform a similar analysis to the closed position. Where there is more than one contactor, the test may open each contactor one at a time. In one example, a zero voltage reading from the sensor output may indicate a functioning operation of the contactors in the open position.

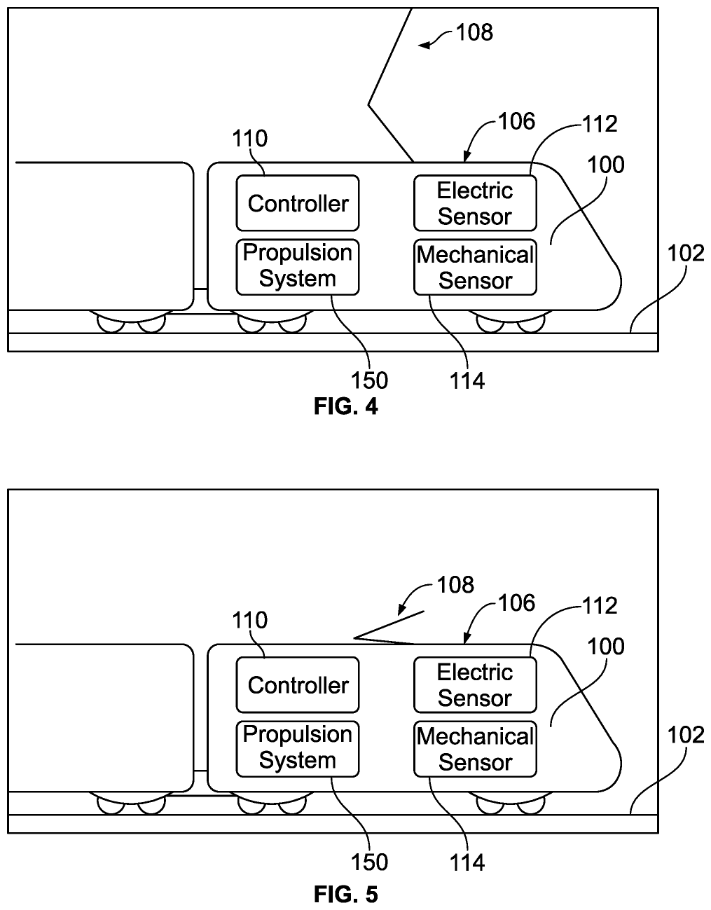

FIG. 4 illustrates an example of the system for testing the collector assembly of the vehicle where the collector assembly may be in a raised or extended position. Prior to initiating the test, the controller may determine a clearance surrounding the collector assembly. The clearance may be determined by evaluating whether the collector assembly may be moved to the raised position without obstruction. If an obstruction is detected that may impact the raising of the collector assembly, the vehicle may disable the test at this location and may move to another location. In one example, the clearance may be a prerequisite to running the test.

Once clearance is confirmed, the controller may direct movement of the collector assembly of the vehicle into the raised position. The controller may direct movement of the collector assembly with or without user or operator interaction. The driver or spindle drive, discussed above, may be moved to the extended position to facilitate the raising of the collector assembly. In the embodiment illustrated in FIG. 4, the collector assembly may be raised away from the conductive pathway to allow the collector assembly to reach a fully raised position that may not be inhibited by the clearance of the conductive pathway. In one embodiment, the controller may raise the collector assembly under the conductive pathway, such that the fully raised position may be where the collector assembly engages the conductive pathway. When the collector assembly is in the raised position, one or more mechanical sensors may measure one or more mechanical outputs. In one example, a height or distance of the collector assembly may be measured. The height or distance of the collector assembly may be measured relative to the roof of the vehicle. In one example, an expansion of the driver of the collector assembly may be measured. In one example, the collector assembly may be spring-loaded by a spring to urge the contactor upward to the raised position. A tension of the spring may be measured by one of the mechanical sensors. The spring may be tested by the mechanical sensor when the collector assembly is in the raised position. The controller may compare the mechanical outputs received to a determined target mechanical output for the raised position. Additionally, the controller may determine the speed at which the collector assembly may move to the raised position. The controller may compare determined speed to a target speed to evaluate the collector assembly. Where the determined speed may be longer or shorter than the target speed, the controller may request inspection of the vehicle.

FIG. 5 illustrates an example of a system for testing a collector assembly of a vehicle where the collector assembly may be in a lowered or retracted position. The controller may initiate movement of the collector assembly of the vehicle into the lowered position. The driver or spindle drive may move to the retracted position to facilitate the lowering of the collector assembly. The mechanical sensors may measure mechanical outputs of the collector assembly, or components thereof, in the lowered position. For example, a mechanical sensor may measure the position of the driver in the retracted position. A mechanical sensor may measure the height or distance of the collector assembly in the lowered position. The height or distance of the collector assembly may be measured relative to the roof of the vehicle. The controller may receive the outputs from the mechanical sensors and compare the outputs to a determined target output for the lowered position. Additionally, the controller may determine the speed at which the collector assembly may move to the lowered position. The controller may compare determined speed to a target speed to evaluate the collector assembly. Where the determined speed may be longer or shorter than the target speed, the controller may request inspection of the vehicle, the collector assembly, or both.

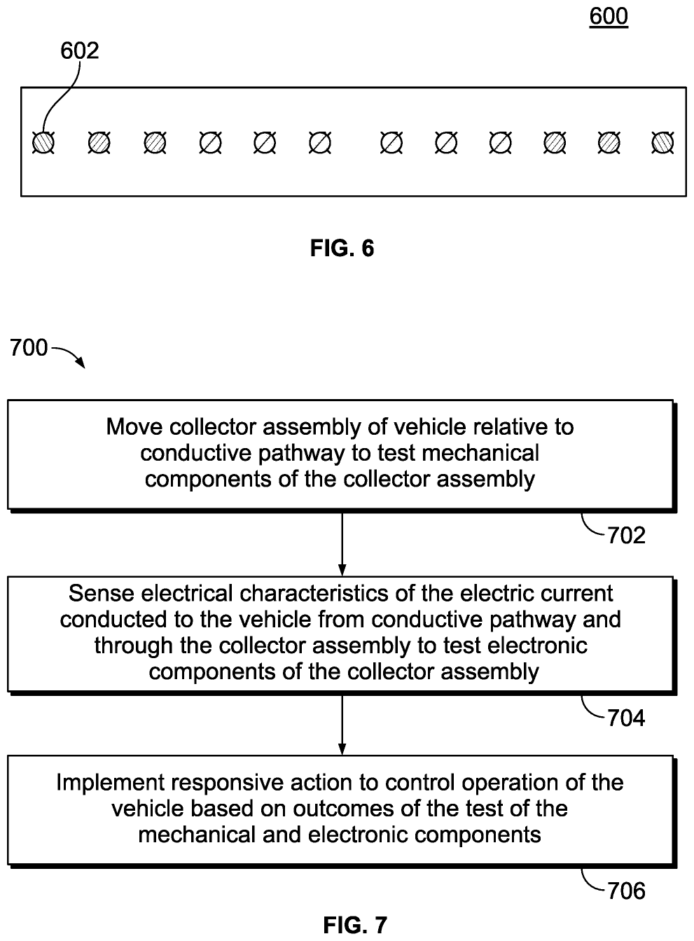

FIG. 6 illustrates an example of a display 600, such as an light-emitting diode (LED) display of the vehicle. The display may facilitate operator or user interaction in order to run the test on the collector assembly. In one example, the display may be onboard the vehicle, such as in an operators chamber of the vehicle. In another example, the display may be offboard the vehicle, such as in a command or control center. The display may include LED lights 602, written or visual instructions, audible instructions, or the like. The display may instruct the operator when and for how long to raise the collector assembly so that the collector assembly may reach a fully extended position. For example, the operator may need to engage a given button for a minimum amount of time for the collector assembly to have time to fully extend. The LEDs may scroll to the right when the operator needs to initiate movement of the collector assembly up. The display may then confirm when the collector assembly has reached the fully extended position. The fully extended position may be confirmed by the display by a written message, audible message, a series of flashing lights, or the like. The display may instruct the operator when and for how long to lower the collector assembly so that the collector assembly may reach a fully lowered position. The LEDs may scroll to the left when the operator needs to initiate movement of the collector assembly down. Additionally, the display may instruct the operator what buttons, levers, shifters, or other controls to engage to initiate and/or facilitate the testing sequence. In the example illustrated in FIG. 5, the outside LEDs may be illuminated when the test is running. When the test is completed, the LEDs may flash all green lights to indicate a passing test and may flash all red lights to indicate a failed test.

In one example, the controller may compare a lower end of a range of movement of the collector assembly to a lower movement threshold. This may allow the controller to evaluate the collector assembly in the lowered position and determine whether the collector assembly is operating as expected. The controller may compare an upper end of the range of movement of the collector assembly to an upper movement threshold. This may allow the controller to evaluate the collector assembly in the raised position. The controller may compare a speed at which the collector assembly raises or lowers to a speed threshold. This may allow the controller to evaluate the speed at which the collector assembly is moving between the raised position and the lowered position to determine whether the collector assembly is operating as expected.

Additionally, the controller may have a determined target or ideal output from the mechanical and electrical tests in the raised or lowered position when all the components are in a fully operational state. The controller may compare the measured output by the mechanical and electrical sensors to the determined target output. Where the measured output may be within a determined range of the target output, the collector assembly may be in a fully operational state. In one example, the determined range may be within 5% however in other examples the determined range may be within 25%. Where the measured output may be outside of the determined range of the target output, the collector assembly may be in a degraded state. The controller may identify when the collector assembly may be in a degraded state based on the measured outputs.

In response to the degraded state, the controller may direct maintenance, inspection, or repair of the collector assembly. The maintenance, inspection, or repair may be directed at a particularly identified component or may be directed at the entire vehicle. The controller may notify the operator of the vehicle of the degraded state. The controller may be able to determine which component may be damaged or degraded based on the measured outputs from the one or more sensors. This may allow the controller to specifically identify components of the vehicle requiring attention.

In one example, the controller may prevent the operation of the vehicle where the outputs are below a minimum threshold. Operation may be inhibited until the test may be rerun and the outputs may be above the minimum threshold. In one example, the controller may identify the measured outputs as being above the minimum threshold but below the determined range. The controller may direct the vehicle to operate in a reduced capacity state in response to the measured outputs being above the minimum threshold but below the determined range. The reduced capacity operation may allow reduced disruption and cost associated with non-essential repairs. In one example, the reduced capacity operation may entail running the engine at a lowered output, such as at 80% capacity. In another example, the reduced capacity may involve running the vehicle with all or some non-essential power loads disabled for the duration or a portion of the trip.

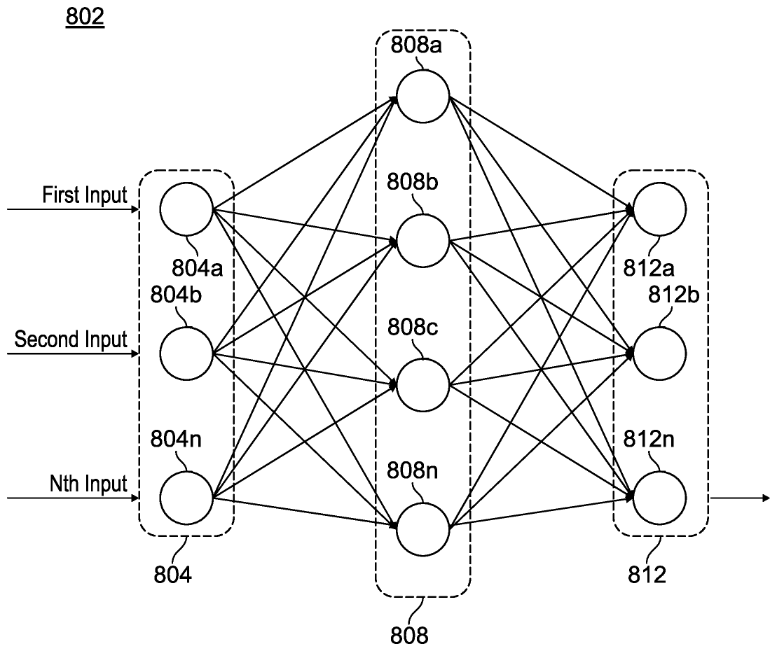

FIG. 7 shows a flowchart illustrating one example of a method 700 for operating the collector assembly the vehicle. At step 702, the method may include moving the collector assembly of the vehicle relative to the conductive pathway to examine or test one or more mechanical components of the collector assembly. This may include using sensors to evaluate the position of the collector assembly or components of the collector assembly. For example, the collector assembly may be moved into a raised position and into a lowered position. The collector assembly may be moved to a fully raised position where the collector assembly may be extended beyond the conductive pathway such that the collector assembly reaches a maximum height. The sensor may evaluate whether the collector assembly may be raising and lowering in accordance to determined thresholds. The sensor may include an optical sensor, an acoustic sensor, a capacitive sensor, an inductive sensor, a photoelectric sensor, a laser distance sensor (e.g., Light Detection and Ranging “LIDAR”), or the like. Function of a driver or motor may be tested while the collector assembly is moved. A sensor may determine whether the driver is in an extended position, a retracted position, as well as determine the speed at which the driver moves between the extended position and the retracted position.

At step 704, the method may include sensing one or more electrical characteristics of the electric current received by the collector assembly of the vehicle from the conductive pathway to test one or more electrical components of the collector assembly or the vehicle. The electrical sensor may include an ohmmeter, a voltmeter, an impedance analyzer, an ammeter, or the like. The electrical characteristics may include a voltage of a breaker in an open and closed position, a voltage of a contactor in an open and closed position, a current leading into or out of the collector assembly, a current between the collector assembly and the conductive pathway, among other characteristics.

At step 706, the method may include implementing one or more responsive actions to control operation of the vehicle based on outcomes of one or more of the examination or test of the mechanical components and the test of the one or more electrical components. In one example, the responsive action may include preventing movement of the vehicle until the tests are passed. In one example, the responsive action may include operating the vehicle in a derated or degraded operation state in response to a detected fault in one or more component. The responsive action may include alerting a user or operator of the vehicle. Additionally, the responsive action may include directing maintenance, inspection, or repair of the collector assembly.

As previously described, one or more of the vehicle testing systems described herein may be implemented in an AI or machine-learning system. FIG. 8 illustrates a functional block diagram of an example neural network 802 that can be used by a control system. The vehicle testing system may review various inputs, described above, for example the tests of the mechanical components (e.g., the height/position of the conductive assembly, the alignment of the conductive assembly and the conductive pathway, etc.), the tests of the electrical components (e.g., the current and/or voltage of the electric energy supplied by the conductive pathway, the position of breakers and/or contactors, etc.), or the like. In an example, the neural network 802 can represent a long short-term memory (LSTM) neural network. In an example, the neural network 802 can represent one or more recurrent neural networks (RNN). The neural network 802 may be used to implement the machine learning as described herein, and various implementations may use other types of machine learning networks. The neural network 802 may include an input layer 804, one or more intermediate or hidden layers 808, and an output layer 812. Each layer 804, 808, 812 includes artificial individual units, or neurons. Each neuron can receive information (e.g., as input into the neural network 802 or as received as output from another neuron in another layer or the same layer), process this information to generate output, and provide the output to another neuron or as output of the neural network 802. The input layer 804 may include several input neurons 804a, 804b . . . 804n. The hidden layer 808 may include several intermediate neurons 808a, 808b . . . 808n. The output layer 812 may include several output neurons outputs 812a, 812b . . . 812n. The inputs may include, for example, the outcomes of the test of the mechanical components, the outcomes of the test of the electrical components, the position of the collector assembly, the alignment of the collector assembly and the conductive pathway, or the like.

Each neuron can receive an input from another neuron and output a value to the corresponding output to another neuron (e.g., in the output layer 812 or another layer). For example, the intermediate neuron 808a can receive an input from the input neuron 804a and output a value to the output neuron 812a. Each neuron may receive an output of a previous neuron as an input. For example, the intermediate neuron 808b may receive input from the input neuron 804b and the output neuron 812a. The outputs of the neurons may be fed forward to another neuron in the same or different intermediate layer 808.

The processing performed by the neurons may vary based on the neuron, but can include the application of the various rules or criteria described herein to partially or entirely decide one or more aspects of the testing system, for example when to allow movement of the vehicle, when to send an alert, when to request inspection, or the like. The output of the application of the rule or criteria can be passed to another neuron as input to that neuron. One or more neurons in the intermediate and/or output layers 808, 812 can determine links between one or more aspects of the testing system, for example when an reading may be determined for a mechanical component. As used herein, a “link” may refer to a preferred operation of the testing system based on the inputs, for example an operation (or lack thereof) of the vehicle given an abnormal mechanical or electrical test outcome. The preferred operation may be based on increasing performance, efficiency, safety, longevity, or a combination of any or all of these factors. The last output neuron 812n in the output layer 812 may output a link or no-link decision. For example, the output from the neural network 802 may be that a component of the collector assembly may need inspection given the outcome of the mechanical component test. Although the input layer 804, the intermediate layer(s) 808, and the output layer 812 may be depicted as each including three artificial neurons, one or more of these layers may contain more or fewer artificial neurons. The neurons can include or apply one or more adjustable parameters, weights, rules, criteria, or the like, as described herein, to perform the processing by that neuron.

In various implementations, the layers of the neural network 802 may include the same number of artificial neurons as each of the other layers of the neural network 802. For example, the outcomes of the test of the mechanical components, the outcomes of the test of the electrical components, or the like may be processed to provide information to the input neurons 804a-804n. The output of the neural network 802 may represent a link or no-link of the inputs to the a given output. More specifically, the inputs can include historical data. The historical data can be provided to the neurons 808a-808n for analysis and links between the historical data. The neurons 808a-808n, upon finding links, may provide the potential links as outputs to the output layer 812, which can determine a link, no link, or a probability of a link.

In some embodiments, the neural network 802 may be a convolutional neural network. The convolutional neural network can include an input layer, one or more hidden or intermediate layers, and an output layer. In a convolutional neural network, however, the output layer may include one fewer output neuron than the number of neurons in the intermediate layer(s), and each neuron may be connected to each output neuron. Additionally, each input neuron in the input layer may be connected to each neuron in the hidden or intermediate layer(s).

Such a neural network-based vehicle testing system can be trained by operators, automatically self-trained by the vehicle testing system itself, or can be trained both by operators and by the vehicle testing system itself to improve how the system operates.

As discussed above, the testing method and system may operate autonomously without user input. Additionally, the testing method may catalog previously run and collected test data. In one embodiment, the control system may have a local data collection system deployed that may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the control system may include a policy engine that may apply one or more policies. These policies may be based at least in part on characteristics of a given item of equipment or environment. With respect to control policies, a neural network can receive input of a number of environmental and task-related parameters. These parameters may include an identification of a determined trip plan for a vehicle group, data from various sensors, and location and/or position data. The neural network can be trained to generate an output based on these inputs, with the output representing an action or sequence of actions that the vehicle group should take to accomplish the trip plan. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other. Determinations may be done in advance, so as to be predetermined, done partially in advance (waiting for certain values before responding), in real time or near real time, and the like based on application specific parameters.

In one embodiment, a method for operating a collector assembly of a vehicle is described. The collector assembly may receive electric current from a conductive pathway extending along a route being traveled by the vehicle. The electric current may power loads of the vehicle. The method may include examining one or more mechanical components of the collector assembly of the vehicle by moving the collector assembly of the vehicle relative to the conductive pathway. The method may include sensing one or more electrical characteristics of the electric current received by the collector assembly of the vehicle from the conductive pathway to test one or more electrical components of one or more of the collector assembly or the vehicle. The method may include implementing one or more responsive actions to control operation of the vehicle based on outcomes of one or more of an examination of the one or more mechanical components or the test of the one or more electrical components.

The examination of the one or more mechanical components of the collector assembly may include one or more of raising the collector assembly or lowering the collector assembly. Moving the collector assembly may include raising a pantograph or lowering a conductive shoe. The method may include measuring a height of the collector assembly in one or more of a raised position or in a lowered position. The method may include measuring a tension of a spring of the collector assembly while the collector assembly may be in a raised position.

In one example, the examination of the one or more mechanical components of the collector assembly may include one or more of comparing a lower end of a range of movement of the collector assembly to a lower movement threshold, comparing an upper end of the range of movement of the collector assembly to an upper movement threshold, or comparing a speed at which the collector assembly raises or lowers to a speed threshold. The examination of the one or more mechanical components of the collector assembly may include extending a driver of the collector assembly to an extended position and retracting the driver to a retracted position. The examination of the one or more mechanical components of the collector assembly may include measuring a position of the collector assembly relative to the conductive pathway.

The test of the one or more electronic components of the collector assembly may include applying a voltage to move a breaker to an open position and measuring a breaker voltage in the open position. The test of the one or more electronic components of the collector assembly may include applying a voltage to move one or more contactors to an open position and measuring a contactor voltage in the open position. The test of the one or more electronic components of the collector assembly may include measuring a current between the collector assembly and the conductive pathway.

In one example, implementing the one or more responsive actions may include preventing operation of the vehicle in response to one or more of the outcomes of the examination of the one or more mechanical components being below a minimum mechanical threshold or the outcomes of the test of the one or more electronic components being below a minimum electrical threshold. In another example, implementing the one or more responsive actions may include one or more of directing maintenance, inspection, or repair of the collector assembly in response to one or more of the outcomes of the examination of the one or more mechanical components being below a first mechanical threshold or the outcome of the test of the one or more electronic components being below a first electrical threshold. Implementing the one or more responsive actions may include operating the vehicle in a reduced capacity state in response to one or more of the outcome of the examination of the one or more mechanical components being below a second mechanical threshold but above a first mechanical threshold or the outcome of the test of the one or more electrical components being below a second electrical threshold but above a first electrical threshold. In another example, implementing the one or more responsive actions may include displaying an alert or notifying an operator of the vehicle in response to one or more of the outcome of the examination of the one or more mechanical components being below a first mechanical threshold or the outcome of the test of the one or more electronic components being below a first electrical threshold.

In one embodiment, a system is provided that may include a collector assembly, a controller, and a first sensor. The collector assembly may be disposed onboard a vehicle that travels along a route. The collector assembly may receive electric current from a conductive pathway extending along the route to power loads of the vehicle. The controller may examine one or more mechanical components by initiating movement of the collector assembly relative to the conductive pathway. The first sensor may sense one or more electrical characteristics of the electric current received by the collector assembly from the conductive pathway to test one or more electrical components of one or more of the collector assembly or the vehicle. The controller may implement one or more responsive actions to control operation of the vehicle based on outcomes of one or more of an examination of the one or more mechanical components and the test of the one or more electrical components.

The collector assembly may include a pantograph or a conductive shoe. The system may include a second sensor that may measure a height of the collector assembly in one or more of a raised position or a lowered position. The controller may compare one or more of: a lower end of a range of movement of the collector assembly to a lower movement threshold, an upper end of the range of movement of the collector assembly to an upper movement threshold, or a speed at which the collector assembly raises or lowers to a speed threshold. In one example, the system may include a driver that may drive the collector assembly. The controller may initiate the driver to move to an extended position and the controller may initiate the driver to move to a retracted position. The controller may receive a measurement of a position of the driver in one or both of the extended position and the retracted position.

In one example, the system may include a third sensor that may measure a position of the collector assembly relative to the conductive pathway. The controller may apply a voltage to move a breaker to an open position. The controller may receive a measurement from the first sensor of a breaker voltage in the open position. The breaker may be an indirect trip circuit breaker or a high speed circuit breaker. The controller may direct one or more of maintenance, inspection, or repair of the collector assembly in response to one or more of the outcomes of the examination of the one or more mechanical components being below a first mechanical threshold or the outcomes of the test of the one or more electronic components being below a first electronic threshold. The controller may notify an operator of the vehicle in response to one or more of the outcomes of the examination of the one or more mechanical components being below a first mechanical threshold or the outcomes of the test of the one or more electronic components being below a first electronic threshold.

In one embodiment, a method for testing a collector assembly of a vehicle is described. The collector assembly may receive electric current from a conductive pathway extending along a route being traveled by the vehicle. The electric current may power loads of the vehicle. The method may include examining one or more mechanical components of the collector assembly by moving the one or more mechanical components of the collector assembly and sensing one or more mechanical characteristics of the one or more mechanical components of the collector assembly. The method may include sensing one or more electrical characteristics of the electric current received by the collector assembly to test one or more electrical components of the collector assembly or the vehicle. The method may include preventing operation of the vehicle until the one or more mechanical characteristics are in a threshold mechanical range and the one or more electrical characteristics are in a threshold electrical range.

In one example, moving the one or more components of the collector assembly may include moving a driver of the collector assembly to an extended position and retracting the driver to a retracted position.

As used herein, an element or step recited in the singular and proceeded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended claims, the terms “including” and “in which” are used as the plain-English equivalents of the respective terms “comprising” and “wherein.” Moreover, in the following claims, the terms “first,” “second,” and “third,” etc. are used merely as labels, and do not impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function devoid of further structure.

The above description is illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein define the parameters of the inventive subject matter, they are exemplary embodiments. Other embodiments will be apparent to one of ordinary skill in the art upon reviewing the above description. The scope of the inventive subject matter should, therefore, be determined with reference to the appended claims, along with the full scope of equivalents to which such claims are entitled.

Use of phrases such as “one or more of . . . and,” “one or more of . . . or,” “at least one of . . . and,” and “at least one of . . . or” are meant to encompass including only a single one of the items used in connection with the phrase, at least one of each one of the items used in connection with the phrase, or multiple ones of any or each of the items used in connection with the phrase. For example, “one or more of A, B, and C,” “one or more of A, B, or C,” “at least one of A, B, and C,” and “at least one of A, B, or C” each can mean (1) at least one A, (2) at least one B, (3) at least one C, (4) at least one A and at least one B, (5) at least one A, at least one B, and at least one C, (6) at least one B and at least one C, or (7) at least one A and at least one C.

This written description uses examples to disclose several embodiments of the inventive subject matter, including the best mode, and to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A method for operating a collector assembly of a vehicle that is configured to receive electric current from a conductive pathway, the method comprising:
examining one or more mechanical components of the collector assembly of the vehicle by moving the collector assembly of the vehicle relative to the conductive pathway;
sensing one or more electrical characteristics of the electric current received by the collector assembly of the vehicle from the conductive pathway to test one or more electrical components of one or more of the collector assembly or the vehicle; and
implementing one or more responsive actions to control operation of the vehicle based on outcomes of one or more of an examination of the one or more mechanical components or the test of the one or more electrical components.

2. The method of claim 1, wherein the examination of the one or more mechanical components of the collector assembly includes one or more of raising the collector assembly or lowering the collector assembly.

3. The method of claim 2, further comprising measuring a height of the collector assembly in one or more of a raised position or in a lowered position.

4. The method of claim 2, further comprising measuring a tension of a spring of the collector assembly while the collector assembly is in the raised position.

5. The method of claim 1, wherein the examining of the one or more mechanical components of the collector assembly includes one or more of comparing a lower end of a range of movement of the collector assembly to a lower movement threshold, comparing an upper end of the range of movement of the collector assembly to an upper movement threshold, or comparing a speed at which the collector assembly raises or lowers to a speed threshold.

6. The method of claim 1, wherein the examining of the one or more mechanical components of the collector assembly includes extending a driver of the collector assembly to an extended position and retracting the driver to a retracted position.

7. The method of claim 1, wherein the test of the one or more electrical components of the collector assembly includes applying a voltage to move a breaker to an open position and measuring a breaker voltage in the open position.

8. The method of claim 1, wherein the test of the one or more electrical components of the collector assembly includes applying a voltage to move one or more contactors to an open position and measuring a contactor voltage in the open position.

9. The method of claim 1, wherein implementing the one or more responsive actions includes preventing operation of the vehicle in response to the outcomes of one or more of the examination of the one or more mechanical components being below a minimum mechanical threshold or the test of the one or more electrical components being below a minimum electrical threshold.

10. The method of claim 1, wherein implementing the one or more responsive actions includes operating the vehicle in a reduced capacity state in response to the outcomes of one or more of the examination of the one or more mechanical components being below a second mechanical threshold but above a first mechanical threshold or the test of the one or more electrical components being below a second electrical threshold but above a first electrical threshold.

11. A system comprising:
a collector assembly that is configured to be disposed onboard a vehicle that travels along a route, the collector assembly being configured to receive electric current from a conductive pathway extending along the route to power loads of the vehicle;
a controller that is configured to initiate movement of the collector assembly relative to the conductive pathway to examine one or more mechanical components of the collector assembly; and
a first sensor that is configured to sense one or more electrical characteristics of the electric current received by the collector assembly from the conductive pathway and thereby to examine one or more electrical components of one or more of the collector assembly or the vehicle, and
the controller is configured to implement one or more responsive actions to control operation of the vehicle based at least in part on outcomes of one or both of an examination of the one or more mechanical components and an examination of the one or more electrical components.

12. The system of claim 11, wherein the collector assembly includes a pantograph or a conductive shoe.

13. The system of claim 11, wherein the controller is configured to compare one or more of:
a lower end of a range of movement of the collector assembly to a lower movement threshold,
an upper end of the range of movement of the collector assembly to an upper movement threshold, or
a speed at which the collector assembly raises or lowers to a speed threshold.

14. The system of claim 11, further comprising a third sensor that is configured to measure a position of the collector assembly relative to the conductive pathway.

15. The system of claim 11, wherein the controller is configured to apply a voltage to move a breaker to an open position, the controller is configured to receive a measurement from the first sensor of a breaker voltage in the open position.

16. The system of claim 15, wherein the breaker is an indirect trip circuit breaker or a high speed circuit breaker.

17. The system of claim 11, wherein the controller is configured to one or more of direct maintenance, inspection, or repair of the collector assembly in response to the outcomes of one or more of the examination of the one or more mechanical components being below a first mechanical threshold or the examination of the one or more electrical components being below a first electrical threshold.

18. The system of claim 11, wherein the controller is configured to notify an operator of the vehicle in response to one or more of the outcomes of the examination of the one or more mechanical components being below a first mechanical threshold or the outcomes of the examination of the one or more electrical components being below a first electrical threshold.

19. A method for testing a collector assembly of a vehicle that receives electric current from a conductive pathway, the method comprising:
examining one or more mechanical components of the collector assembly by moving the collector assembly and sensing one or more mechanical characteristics of the one or more mechanical components of the collector assembly;
sensing one or more electrical characteristics of the electric current received by the collector assembly to test one or more electrical components of the collector assembly or the vehicle; and
preventing operation of the vehicle until the one or more mechanical characteristics are in a threshold mechanical range and the one or more electrical characteristics are in a threshold electrical range.

20. The method of claim 19, wherein moving the one or more components of the collector assembly includes extending a driver of the collector assembly to an extended position and retracting the driver to a retracted position.
